(19) United States
(12) Patent Application Publication
(10) Pub. No.: US 2006/0161506 A1
(43) Pub. Date: Jul. 20, 2006

(54) Method and device for processing graphical information located on surfaces of postal articles

(75) Inventors: Dieter Stumm, Grossefehn (DE); Carsten Vullriede, Hodenhagen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/541,288

(22) PCT Filed: Dec. 18, 2003
(86) PCT No.: PCT/DE03/04170

§ 371 Date: Feb. 13, 2006

(30) Foreign Application Priority Data
Jan. 2, 2003 (DE) 103002979

(51) Int. Cl. B65B 35/00; G06F 17/00; G07B 17/02

(52) U.S. Cl. 705/408; 705/406

(57) ABSTRACT

The aim of the invention is to provide a method that enables an examination of postage paid impressions on bulk mailings and/or a billing of charges for bulk mailings, whereby the method, above all, should be suitable for billing specific types of delivery. The inventive method is carried out in such a manner that it can be used for processing large quantities or postal articles and, in particular, can be integrated into processing processes in letter or parcel distribution centers. According to the invention, graphical information located on the surface of the postal articles are detected and items of information are determined. These items of information are used for assigning the postal articles to a respective type of delivery during which an address of an addressee, and a detail that identifies the postal article and/or identifies a deliverer of the postal article is determined, and during which the number of postal articles delivered by a deliverer is established. The determined items of information are associated with one another in such a manner as to establish a delivery structure, and the established number and the established delivery structure are compared with a delivery job batch, which contains a number of the delivered postal articles and a delivery structure and which is conveyed by a customer, and/or a delivery job batch containing the number and the delivery structure is created. In addition, the deliver job batch is compared to a customer record that contains a prepaid postage amount and/or a limit for a postage amount.

The invention relates to a method for processing mailpieces with which graphic information located on the surface of a mailpiece is detected and checked in the area of a mail processing station, after which said information is transmitted to an image processing unit and is further processed by said image processing unit.

The invention also relates to a device that is suitable for executing the method.

International patent application WO 98/17405 A1 discloses a method and a device for online processing of mailpieces that are to be forwarded. With this method, an image of the mailpiece is made and the mailpiece is transported to an intermediate storage area. After the digitalization of the image of the mailpiece, areas with information of interest are ascertained and written forwarding instructions present on the mailpieces are read.

The international patent application WO 01/04768 A1 discloses a message-based OCR server. Here, a device is made up of a processor and a computer-readable medium that is encrypted with program commands, whereby the program commands can be executed on the processor in order to receive a first message from a remote computer, whereby the message contains image data. At least part of the image data is converted into text data and a second message is sent to the remote computer. This second message contains the text data.

German Preliminary Published Application DE 198 58 229-A1 describes a method and a device for recording mail and the associated postage indicium, whereby the weight of the mailing is automatically checked in a mail conveying segment.

German Preliminary Published Application DE 197 37 232 A1 describes an electronic method for franking mailpieces with which a barcode issued by a central computer is used for the payment-related identification of franked mailed items. This barcode can be applied by any commercially available PC printer onto any postal article without a need for any additional equipment.

U.S. Pat. No. 5,229,932 describes a method and an apparatus for categorizing and certifying mailpieces. For mailed bulk mailings, the class, the number, the size and the weight of the mailpieces are determined, and the ZIP code contained in the address is read in order to determine the geographical destination region and the readability of the address block as well as to verify the address. All of this information is stored and a report is drawn up that, in addition to the detected information, also contains the postage determined on this basis. This report is compared to the delivery information of the customer, whereby especially the amount of postage paid is verified.

An analogous method and an analogous device are known from European patent application EP 0 356 228 A2, except that the information is not ascertained for each mailpiece but rather the detection is limited to a number of random samples from which conclusions are drawn about the corresponding information for all of the mailpieces within a bulk mailing.

European patent application EP 0 373 972 A2 discloses a system for checking postage that comprises calibrated scales and a reading unit that are connected to a computer. When the bulk mailing is mailed, in addition to the weight and the address of the individual mailpieces, the number of mailpieces is likewise ascertained and this information is transmitted to the computer. On the basis of a table, the postage to be paid is determined for each mailpiece, and this is printed onto the mailpiece. If the mailpieces already have a franking imprint, this information is detected and compared to the postage to be paid.

European patent-specification EP 0 589 723 B1 relates to a mail processing system for checking the postage amount, said system comprising scales and a franking machine that prints onto the mailpieces the postage established on the basis of the weight. The printing of the correct postage can be preceded by the reading in of the postal code of the recipient's address, and the mailpieces within a bulk mailing can be sorted according to the postal codes so that discounted postage is printed onto the mailpieces if a certain number of mailpieces has accumulated for a certain postal code.

U.S. Pat. No. 4,821,195 discloses a method and a device for sequentially numbering mailpieces. For purposes of franking mailpieces, the customer of a postal service receives a postage value which is loaded into a register in an access unit, whereby the postage is transmitted together with a transaction number. The mail-pieces are provided with the postage of the transaction number as well as with a consecutive number and, for a bulk mailing, a report is printed that contains the total postage as well as the number of mailpieces contained therein. On the basis of the transaction number and the consecutive numbering, it can be ascertained whether the mailpieces have valid franking.

Moreover, German patent DE 100 56 599 C2 describes a method for sending mailpieces with postage indicia with which a customer system loads a postage value, from a value transfer system and the customer system controls the printing of postage indicia onto mailpieces. The data transmitted from the value transfer system is encrypted using a random number, and a background system checks whether the amounts of credit present in the customer system are, in fact, reduced by the postage amounts that are printed as postage indicia onto the mailpieces.

The invention is based on the objective of creating a method that allows postage indicia on bulk mailings to be checked and/or bulk mailings to be invoiced, whereby the method, above all, should be suitable for invoicing specific mailing types. The invention is especially based on the objective of carrying out the method in such a way that it can be used for processing large volumes of mail and, in particular, that it can be integrated into mail or parcel distribution centers.

According to the invention, this objective is achieved by a method according to Claim 1.

It is provided that information is ascertained on the basis of which the mailpieces can each be associated with a product type, that at least one piece of information that identifies the mailpiece and/or a mailer of the mailpiece is ascertained—at least in part—on the basis of the detected graphic information, that it is determined how many mailpieces of the mailer were processed, and that the number of processed mailpieces is compared to the delivery job batch.

Examples of possible mailing types are standard mailing types offered by the postal service provider that is carrying out the method, for instance, standard letters, compact letters and large-format letters.

However, it is also possible to define separate mailing types for certain mailers or for certain groups of mailers.

The classification of the mailpieces into mailing types is preferably carried out in that their dimensions and/or their weight is ascertained. In an application that serves by way of an example involving four different mailing types (standard letters, compact letters, large-format letters and maxi-letters), each of the individual mailing types can be associated with minimum and maximum lengths and widths as well as with a maximum height and a maximum weight.

Hence, the invention is by no means limited to being used only with such standard mailing types. The invention is especially suitable for invoicing specific mailing types such as, for example, pre-sorted mailings.

Such invoicing is preferably carried out in that the detected data items of different mailpieces are combined with each other in such a way that a delivery structure is ascertained which yields the payment-relevant information.

Payment-relevant information includes, for example, identifying data as well as information about the number and product type, and also about the presence of a postage indicium and whether its amount is correct.

The payment-relevant information, however, is not limited to the above-mentioned examples. This term encompasses all parameters that can be used for invoicing mailpieces, for example, also features on the basis of which a postage reduction is granted—for instance, if the mailer pre-sorts the mailpieces, then the existence and the correctness of this pre-sorting is checked and this is taken into account for the invoicing.

The speed with which the graphic information is analyzed can be increased according to the invention in that the analyses are first carried out on the local level and then, in a second step, in a central database. Here, the detected information is compared to data material present in a database and determined or specified for certain conditions to be defined for subsequent processes.

It is especially advantageous to carry out a sorting of the mailpieces as a function of the previously analyzed data. For example, mailpieces that do not have enough postage are diverted from the processing sequence, or they are conveyed to an intermediate storage area where they remain until it has been ensured that sufficient payment was made for that particular mailpiece. This payment-specific handling of the mailpieces can be carried out with various methods and processing devices. A combination of several of the method and device features disclosed in this patent application is especially advantageous.

Advantageously, an important feature of the analysis is that the mailpiece is supposed to be delivered under certain conditions. This is why the product type, payment of the mailpiece, mailpiece number, detection data, detection time, the customer number or identification number, etc. are all recorded.

Another possible work step is to analyze the contracts on which the shipping order is based with reference to special characters (e.g. certain identification numbers of a customer's franking means, presence of an order number or the like) and—if the overall result is positive—to provide the confirmation of a delivery structure to a central customer data management system.

Insofar as desired or necessary, this delivery confirmation can be sent by the system to the customer automatically or upon request.

Subsequent to the sending of this mailing information to the central customer data management system, it is advantageous to create a job batch, insofar as the customer did not centrally report a job by electronic order to the postal service provider. The job batch can be used for the later invoicing for the services rendered by the postal service provider.

According to the invention, this job batch should preferably create a sufficiently concrete customer data structure via the information in the central customer data management system and this structure should be locally stored at the distribution center where the graphic information was detected (customer data management system—local). As a supplement to the usual data in the customer data record, in this context, data such as, for example, advance payment amounts and/or customer limits should also be transmitted in order to utilize the full potential of the system with the subsequent resultant processes.

If there are discrepancies between the detected information and the customer target data of the job (e.g. the order), then the system generates a differential protocol (Delta protocol) and sends it to the customer data management system on the local level. As the next step, according to the invention, clearing information is required as the answer from the customer. Subsequently, system-supported or manual refund procedures and/or additional payment procedures can be initiated.

According to the invention, the task of the distribution center is to use this sequence for the detected graphic information of all of the mailpieces in order to compile the data per job and per customer number and to store this in the central customer data management system.

Processing mailpieces with different franking can be achieved in that the graphic information located on the surfaces of the mailpieces is associated with one or more of the expected mailing types and in that the checking is carried out in reading devices specialized for those types of franking.

Here, an association of the graphic information with standardized franking systems and specialized reading devices is advantageous, even when the graphic information is detected by a central image processing unit that uses standardized interfaces to supply special reading devices with digital information.

Examples of these specialized reading devices are devices that can determine encoded data contained in the graphic information by decrypting the code and that can compare said information to other data. For example, such specialized reading devices serve to detect information from encoded data contained in digital postage indicia.

Such reading devices are examples of image processing units in a device that is suitable for carrying out the method.

At a fixed point in time, these locally detected items of information (jobs) are reported from all of the mail centers to the customer data management system so that a customer-related detection of the graphic information can take place.

In an especially preferred embodiment of the invention, the individual jobs are combined in a next step, taking into account information, namely, periodical data stored in the central customer data management system. Once the end of a detection time period has been reached, then the customer invoicing data—listing the mailing data and the detection times as well as products and individual prices—is transmitted to the financial accounting department and to a central invoicing office.

In order to efficiently ensure sales for the DPWN (Deutsche Post World Net), a special encoding feature can be provided for the mailpieces for which there is no order or no customer release for the detected mailing volume, individual mailpiece prices or discount categories based on the determination of the DPWN, as a result of which the non-released mailpieces are diverted in a special procedure according to certain payment assurance criteria.

Likewise, according to the invention, mailpieces of certain customers who have provided us with a detection authorization and direct-debit authorization can be invoiced automatically and at appropriate intervals.

Especially preferred embodiments of the invention are characterized in that the detection and processing of graphic surface information on the mailpieces is used to transmit a delivery confirmation to the mailer (customer)—preferably via the central customer data management system—and to generate invoicing information on the basis of the analysis of the automatically detected information.

In particular, it is advantageous to record mailpieces (deliveries) for which there are no contractual agreements and/or that have no other indication of sufficient franking.

Such mailpieces can be either diverted and returned to the mailer (customer) or else, if a detection authorization and direct-debit authorization from the customer exist, they can be recorded and subsequently invoiced—for instance, at appropriate intervals or when a certain mailing volume has been reached.

It is especially advantageous to carry out the method in such a way that at least one additional piece of payment-relevant information about every single mailpiece is detected.

An especially preferred embodiment of the invention is characterized in that the ascertained information is linked together in such a way that a delivery structure is generated.

The term delivery structure has a multifaceted meaning, supported by the present invention.

For example, it refers to information indicating at which mail centers or freight centers how many mailpieces of certain mailing types or having other prescribed or pre-definable properties were mailed.

An example of an especially payment-relevant delivery structure is the presorting of the mailpieces. By pre-sorting the mailpieces—for example, on the basis of the postal codes of each individual recipient—the processing operation for the mail-piece can be carried out in a manner that diverges from the way in which a standard mailpiece is handled.

However, it is, of course, also possible to grant a discount for the presence of a delivery structure in cases when the processing operation for the mailpiece remains unchanged.

However, it is especially advantageous to check the presence and optionally the correctness of a pre-sorting so that the particular mailer can receive a payment reduction for having carried out the pre-sorting.

An especially preferred embodiment of the checking of the pre-sorting carried out by the mailer comprises checking whether the pre-sorting was carried out on the basis of addresses of recipients.

This is advantageously done by checking whether the pre-sorting was done on the basis of the postal codes of each individual recipient of the mailpieces.

Moreover, it is advantageous to determine whether the mailpieces were pre-sorted according to mailing properties, for example, according to the individual weights, or weight classes.

Moreover, it is advantageous that it is ascertained for the mailpieces whether they have an identification number, and that the identification number of the mailpieces is used for the invoicing.

An especially preferred embodiment of the invention is characterized in that it is ascertained for the mailpieces whether they have a customer number and in that the customer number of a mailer is used for the invoicing.

Moreover, it is advantageous that, on the basis of the number of mailpieces of the mailer and/or of the ascertained delivery structure, an invoicing database is ascertained.

This is advantageously done in that the delivery job batch is transmitted to a customer data management system, and in that the customer data management system determines whether there are discrepancies between the invoicing data record and the delivery job batch, and in that, if there are discrepancies between the invoicing data record and the delivery job batch, the customer data management system records these in a differential protocol.

Moreover, it is advantageous to check whether a customer has transmitted a delivery job batch, and, if the customer has not generated a delivery job batch, for a delivery job batch to be generated automatically.

An especially advantageous embodiment of the invention is characterized in that, on the basis of the detected information, a delivery confirmation is issued to the mailer.

The delivery confirmation can be transmitted to the mailer in various ways. As a matter of principle, push processes as well as pull processes are suitable for this. Examples of push processes include e-mails, SMS or automatically generated mail pieces. Examples of pull processes include information that is provided for downloading from a website.

It is advantageous to adapt the delivery confirmation to the requirements of the mailer. Whereas some mailers, for example, would like to have a confirmation that every single mailpiece was recorded—preferably on the basis of the individual identification number of the mailpiece—other mailers need less detailed information, for example, only relating to the payments to be made and/or to the correctness of the delivery parameters, for instance, a pre-sorting that may have been carried out.

According to the invention, delivery confirmations for individual mailpieces as well as delivery confirmations are implemented via a delivery structure.

An increase in the speed of the processing of the graphic information can advantageously be achieved in that the graphic information located on the surface of the mailpieces is first evaluated locally, in that it is determined whether the graphic information diverges from the expected graphic information, and in that the ascertained graphic information is transmitted to a central image processing unit if the ascertained graphic information diverges from the expected graphic information.

It is especially advantageous for the mailpieces to be sorted as a function of the ascertained graphic information.

The graphic information present on the mailpieces is preferably also used for further applications, for example, in order to achieve a fast and reliable addressing of the mailpieces.

Another advantageous refinement of the invention is characterized in that the correct payment for the mailpieces is checked by comparing the graphic information located on the mailpieces with the expected graphic information.

In order to further enhance the efficiency of this method, it is advantageous for the checking as to whether the mailpieces have an expected payment to take place in two stages, whereby first of all, the graphic information located on the mailpieces is compared to the expected graphic information locally in the area of the processing machines, and in that the graphic information of the mailpieces for which discrepancies between the actual graphic information and the expected graphic information were ascertained in the local processing stations undergoes another comparison between the ascertained graphic information and the expected graphic information in the central image processing unit.

Processing mailpieces with postage indicia that differ from each other can be achieved in that the graphic information located on the surfaces of the mailpieces is associated with one or more expected mailing types, and in that the checking takes place in reading devices specialized for those types of postage.

Here, it is especially advantageous for the graphic information and the reading devices to be associated by the central image processing unit.

Examples of these specialized reading devices include devices that can determine encoded data that is contained in the graphic information by decrypting the code and that can compare said information to other data. For example, such specialized reading devices serve to detect encoded data contained in digital postage indicia.

Such reading devices are examples of image processing units in the device that is suitable for carrying out the method.

An especially suitable device for processing mailpieces comprising several processing machines for the mailpieces—whereby the processing machines comprise means for detecting graphic information located on the mailpieces—is characterized in that the means for detecting the graphic information are connected to at least one means for processing the graphic information in such a way that the means for processing the graphic information can process the graphic information from several processing machines.

Additional advantages, special features or practical refinements of the invention can be gleaned from the subordinate claims and from the following presentation of preferred embodiments.

In the following presentation, a processing center for mailpieces, for example, a mail center or freight center, has a central image processing unit. The appertaining presentation is especially advantageous since it allows the most efficient possible use of computing capacities while only requiring a small amount of data transmissions between the various computer units.

The invention, however, is not limited to the examples presented here. For example, a processing center for mailpieces can comprise several central image processing units or a central image processing unit can process the graphic information coming from several mail centers or freight centers.

In the example below, the image processing system within a mail center having other components is connected to a local computer network.

The image processing system has a connection to each of the mail processing machines, especially the address reading machines or the video encoding stations.

In the case presented here, the image processing system serves to process mailpiece images that could not be successfully read by the primary readers of the image processing machines. As an alternative, it is possible to process the mailpiece images of essentially all of the primary readers by using the central image processing unit. For example, this processing can be carried out independently of the reading result of the primary readers.

The image processing system receives the graphic information located on the mailpieces as well as preferably additional accompanying information from the image processing machines.

An especially fast and reliable processing of the mailpieces can be achieved in that the accompanying information contains results of one or more checking steps.

The graphic information located on the mailpieces can be processed sequentially as well as in parallel.

In particular, it is advantageous to carry out the method in such a way that available image processing capacities are utilized as efficiently as possible by effectively distributing the image processing tasks among various image processing units.

In the image processing system presented here, the image processing units that are locally connected to the processing machines function as primary readers and the specialized reading units function as secondary readers. However, it is likewise possible for the image processing units of other processing machines to function as secondary readers. In this manner, the available processing capacity of each of the image processing devices is utilized.

Such an approach is especially well-suited for rapidly adapting the image processing capacities to special circumstances during operations. For example, if mechanical components of a mail processing machine malfunction, its available image processing capacity can be utilized by the other image processing machines so that, even in case of operational malfunctions, a disruption of the processing of the mailpieces is avoided to the greatest extent possible.

Through the measures described here, the image processing operation can be carried out quickly, effectively and reliably.

Preferably, the image processing operation comprises the following steps:

First of all, the graphic information located on the mailpieces is detected, for example, by one or more sensors and/or a camera.

If the information is not already detected in digital form, a digitalization of the graphic information is advantageous.

Subsequently, the graphic information undergoes one or more image processing steps.

The image processing steps can become an evaluation of the graphic information as well as a systematic forwarding of the graphic information to a specialized image processing unit and/or to an image processing unit that has free processing capacity.

The term image processing, or image processing unit, is thus not to be understood in any limiting manner whatsoever. In particular, it comprises the transformation of the graphic information into additional graphic information, for example, its conversion into another format, the forwarding of the graphic information and/or the evaluation of the additional graphic information that is contained in or can be detected from the graphic information, as well as the reading of a recipient's address or the decryption of encoded data contained in the graphic information.

Moreover, the term image processing also encompasses the features that are sometimes referred to as image interpretation in the field of image processing. This also includes, for example, the decrypting of recipient's addresses of recipients by reading the graphic information that contains the recipient's address (for example, in handwritten form).

Preferably, the various image processing steps are distributed among various image processing units as a function of the particular specification of the image processing unit and/or of the free capacity of the image processing units.

For example, the mailing sequence for mailpieces containing digital postage indicia can be carried out as follows:

In a first image processing unit, which is preferably associated with one of the processing devices for mailpieces, first of all, a separate process routine checks whether the local image processing unit has sufficient processing capacity for processing the graphic information located on the mailpiece.

If this is not the case, then the graphic information is forwarded to another image processing unit that has free capacity.

Moreover, if the image processing unit associated with the processing machine for the mailpiece has sufficient capacity for processing the image data, then it is advantageous to forward the detected graphic information for individual mailpieces.

A forwarding of the graphic information is especially advantageous if the graphic information partially or completely matches a specific postage indicium.

In particular, such a forwarding is advantageous if the graphic information matches a specific type of franking, for example, sender franking or digital franking.

The image data of such mailpieces is forwarded to the specialized readers for the types of franking “sender franking” and “digital postage indicia” (digital franking).

If the presence of such a type of franking is detected, then the applicable checking steps are carried out.

For instance, the sender franking reader, as an example of a specialized reading device takes over the mailpiece image from the central image processing unit.

The sender franking reader then seeks a sender postage indicium within an expected franking zone. The imprint of the sender postage indicium preferably consists of three parts from which the sender franking reader recognizes the franking imprint.

Preferably, these are the payment stamp imprint involving recognition of the canceling machine, the date stamp imprint and the additional field for sender information and advertising.

The sender franking reader recognizes the payment stamp imprint in its entirety and identifies it on the basis of one or more suitable graphic symbols, for example, a post office logo present in the payment stamp.

Subsequently, the sender franking reader reads the identification of the payment stamp and the imprinted payment amount.

In case the franking imprint cannot be read or does not match an expected franking imprint, a warning message is generated.

Such a warning message can preferably have the form of a suitable payment assurance code, for example, as a so-called payment assurance encoding, and it can indicate a possible reason for suspicion of fraud.

Examples of such payment assurance encoding include the information that the identification or the postage indicium are not readable.

When digital postage indicia are used, the encrypted information contained, for example, in the postage indicium is compared to the unencrypted information contained on the appertaining mailpiece.

In case of discrepancies, for example, in case the mailpiece contains a recipient's address that does not match any of the encrypted addresses contained in the digital postage indicium, then this mailpiece is likewise provided with a payment assurance code.

The mailpieces provided with such a payment assurance code can be processed by additional suitable checking steps and/or they can be systematically diverted from the mailing sequence.

The image processing method presented here is particularly suitable for such use in a payment assurance system, but it can also be used to more efficiently control the processing of the mailpieces.

Additional advantages, special features and practical refinements of the invention can be gleaned from the subordinate claims and from the following presentation of preferred embodiments which make reference to the drawings.

The drawings show the following:

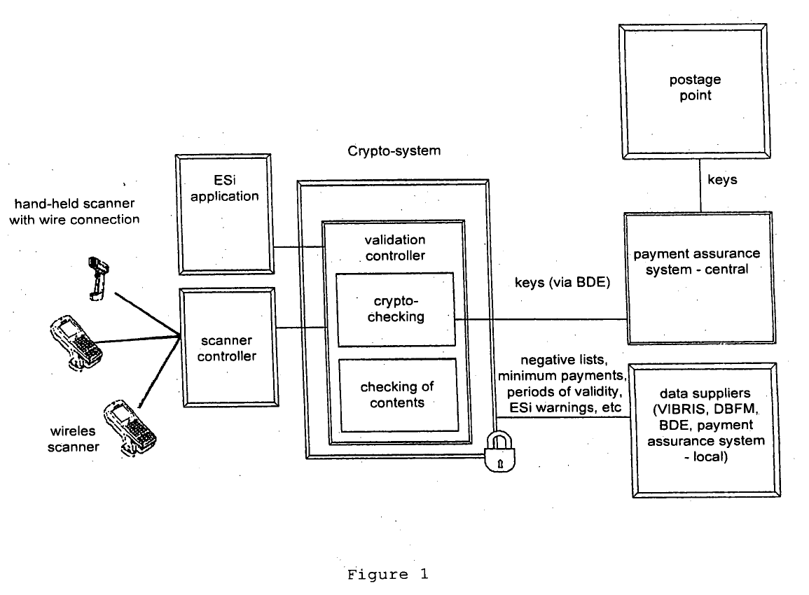

FIG. 1 a schematic diagram of system components of a payment assurance system;

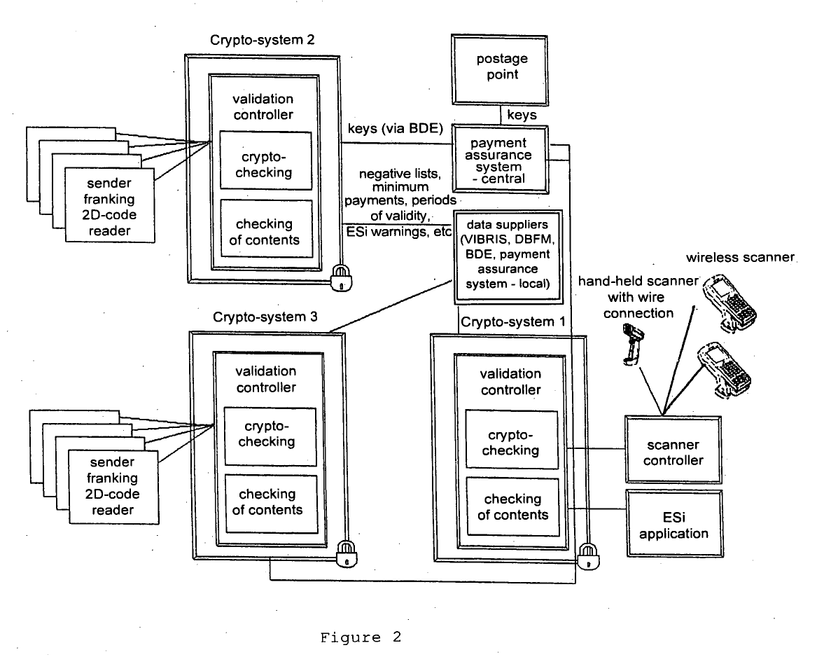

FIG. 2 an especially preferred embodiment of a payment assurance system, a hand-held scanner and a payment assurance PC;

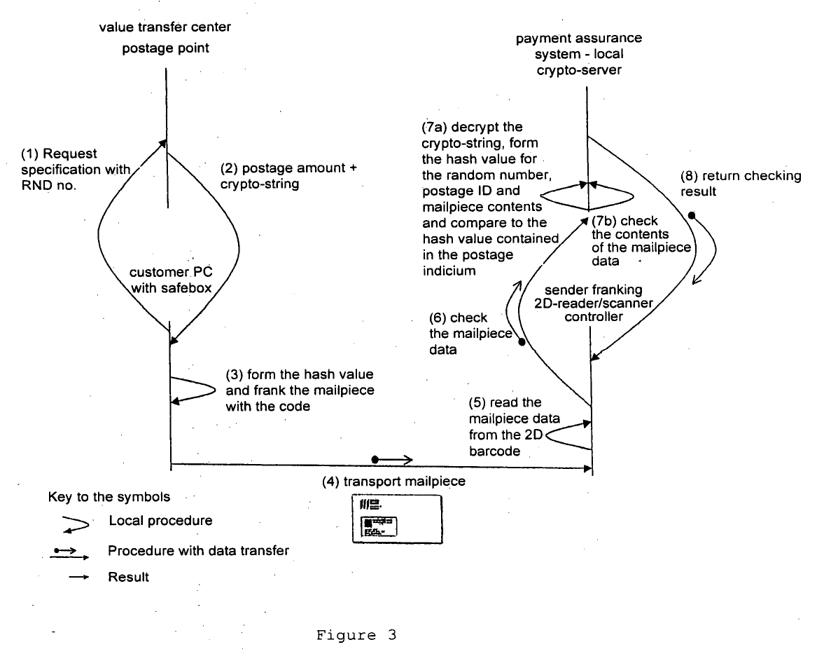

FIG. 3 a schematic diagram of the generation and checking of postage indicia and

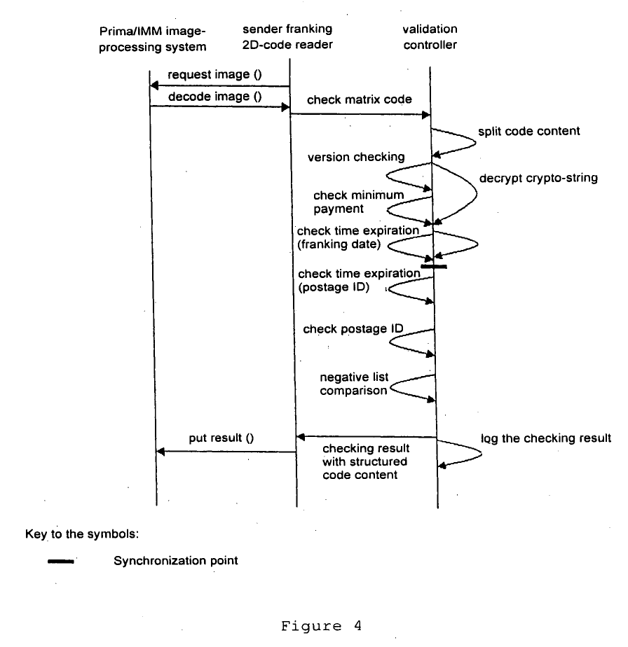

FIG. 4 another especially preferred embodiment of the checking method with an especially preferred sequence of partial checks.

Below, the invention will be explained on the basis of the example of sender franking. However, it is likewise possible to use the invention for mailpieces that were not provided with postage indicia. In this case, it is especially advantageous to provide the individual mailpieces with identification data about the particular mailpiece and/or about the mailer of the mailpiece, so as to allow invoicing.

Insofar as previously generated digital postage indicia are checked, this can be done especially suitably by means of a crypto-system. The term crypto-system refers to a system that is capable of decrypting encrypted information and optionally of evaluating it.

The depicted examples pertaining to cryptographic postage indicia are only intended by way of example and can be used for any other type of postage indicium or—and this is another important advantage—they can be used for mailpieces that have been marked or are identifiable in any desired manner.

The invention is suitable for processing operations in which mailpieces do not have sufficient postage—either inadvertently or else due to manipulation attempts on the part of fraudulent mailers—as well as for application cases in which a mailer delivers unfranked mailpieces.

In this advantageous case, the postal service provider in question offers a franking service to the mailer. This means that the postal service provider carries out the franking of the mailpieces for the mailer and then invoices the mailer for the franking said postal service provider has carried out, optionally charging a fee for having done so.

The described decentralized checking at individual checking stations, particularly at mail centers, is especially preferred, but centralized checking is likewise possible.

In a first embodiment of the invention, the authenticity of the postage indicia is preferably checked on the basis of random sampling by individual scanners.

A checking system that is suitable for this purpose preferably contains the components shown in FIG. 1.

Thus, FIG. 1 shows the partial systems to which the crypto-system is connected. They will be described briefly below.

Scanner

The scanners serve to read in the digital postage indicium of the digital franking. These postage indicia are preferably 2D-codes in the format of a data matrix, with the utilized error correction ECC200. Depending on the type of scanner, the data is transmitted wirelessly or by cable, whereby the wireless scanner has a multi-line display and thus an output possibility as well as a touch screen or a keyboard for rudimentary input.

Scanner Controller/Validation Controller

The interfaces between the scanners and the remaining systems of the preferred payment assurance digital franking system are made up of the scanner controller and the validation controller as components. The scanner controller administers a queue of matrix codes, said queue coming from the hand-held scanner and being available to be checked, and the scanner controller essentially maintains contact with the scanners and is in contact with the rest of the system only via the validation scanner.

The scanner controller and the validation controller serve as an interface between the scanners and the other systems for checking the 2D-barcodes. The 2D-barcode content, which has come from the optical detection and which has been converted and error-corrected, is transmitted to the scanners and the other systems; these then initiate the checking and, in the case of the wireless scanner, they provide an output of the reading and checking result, and they serve as an interface between manual reprocessing and checking by the examiner that might be necessary and the other systems.

Crypto-System

The crypto-system carries out the content-related and cryptographic checking of the 2D-barcode content as well as the protected storage of safety-relevant data and algorithms.

Postage Value Loading Station (Value Transfer Center)

The postage value loading station (value transfer center) is the central system within the digital franking set-up. It serves as the interface to the customer systems. The customers can withdraw specified amounts from this station for use in subsequent franking. The keys for securing the method are generated at the postage value loading station (value transfer system). Moreover, it serves as the interface to the invoicing systems. The following interfaces are provided for the preferred payment assurance system for purposes of digital franking:

mailing information via the 2D-barcode

symmetrical keys

master data such as, for example, specified amounts, account balances

Preferred Central Payment Assurance

The mailing-related information is collected in the preferred central payment assurance system and made available to other systems. This is where the production reports are created which, in turn, lead to the creation of negative files. Moreover, the central payment assurance system receives the current key data from the postage value loading station and then forwards it to the individual crypto-servers.

Data Suppliers

In order to check the content of the 2D-barcode, certain master data is needed such as, for example, negative files, minimum payments, validity periods in relation to the product and payment assurance warning codes and sequential processing codes. This data is supplied by different systems (BDE, VIBRIS, local payment assurance system).

Payment Assurance Application

With the payment assurance application, the checking unit that has to reprocess the diverted PC-franked mailpieces has the capability to carry out a detailed checking of the franking, whereby the presentation of the checking results is not limited by the output possibilities of the scanner. In addition, the examiner can view other data here as well such as the validity period of the postage value related to the current mailpiece, as well as the amount and the franking that was used.

Automatic Detection of the 2D-Barcodes

The automatic detection of the 2D-barcodes is carried out within the SSA. For this purpose, the image information is forwarded to the sender franking 2D-code reader. There, the image is converted into the content of the data matrix code. Subsequently, the 2D-barcode content is transmitted to the crypto-system for checking, the returned checking result is evaluated and transmitted to the optical detection system (IMM) for purposes of encoding the mailpiece. Preferred components of such an expanded checking method are shown in FIG. 2.

Sender Franking 2D-Code Reader

For each reading machine (ALM/ILVM), there is a sender franking 2D-code reader that receives the image data of the mailpieces via an optical detection system (IMM) and further processes this data for purposes of payment assurance. Within the scope of preferred payment assurance digital franking, this means that, if a 2D-code is recognized, the 2D-data matrix code is extracted from the image data and, using the error-correction procedure ECC200, it is converted into a byte string that constitutes the content of the 2D-barcode.

This byte string is transmitted to the validation controller to be checked. The checking result is then forwarded via the interface of the optical detection system and used there for encoding purposes.

Crypto-System for Sender Franking 2D-Code Readers

The term sender franking used in the description means that the sender has carried out the franking. Such a sender franking can be generated in various ways, for example, by a franking machine belonging to a user or by the franking service offered by the postal service provider that performs the entire procedure as described in this invention.

Depending on the properties of the crypto-cards, approximately 27 checking procedures per second can be assumed. Since the rate of the reading machines is about 10 mailpieces per second, it does not seem to be practical to combine each of the sender franking 2D-code readers with a crypto-system. In addition, it cannot be assumed that 100% of the PC-franked mailpieces are produced simultaneously on all of the machines. Thus, it seems practical to separate the crypto-systems and to operate several PC-franking readers with one crypto-system. The approach selected here should be such that it can be scaled, that is to say, that several crypto-systems are possible per mail center. This is relevant, for example, for mail centers with a high mail volume and with a large number of reading machines, where a second crypto-system can be provided right from the start. Moreover, during the actual operations later on, the number of servers can be increased as the need arises.

In order to reduce the complexity, the architecture should preferably be selected in such a way that the individual reading machines are associated with a crypto-system in a fixed manner and conceivably still supplemented with an additional fallback configuration that, in case of an error, attempts to switch over to another crypto-system.

The separation of the crypto-system and the sender franking 2D-code reader also entails the advantage that the machine reading as well as the checking with the hand-held scanner can be carried out with the same crypto-system, as a result of which the same function does not have to be implemented twice, which additionally entails essential advantages in the implementation of the invention.

FIG. 3 shows preferred process steps for providing a mailpiece with a digital postage indicium after loading a postage value from a central loading station (value transfer center) and for generating the postage indicium by means of a local PC as well as the subsequent delivery of the mailpiece and checking of the postage indicium that has been applied onto the mailpiece.

Irrespective of the key distribution, the sequence is such that customers first load a postage value onto their PC's.

In order to characterize the request, a random number is generated here. In the postage value loading station (value transfer center), a new postage value is generated for the customer in question and, on the basis of the transmitted random number, additional information is generated about the identity of the customer system (the customer system information data, hereinafter referred to as the identification number of a customer's franking means) and, for the postage value, the so-called crypto-string is created that is encrypted with a secret symmetrical key that exists in the value loading station (value transfer center).

This crypto-string and the corresponding postage value are subsequently transmitted to the customer PC and, together with the random number, are stored in the PC's “safe box” where it is secure against unauthorized access.

If, after this procedure, the customer franks a mailpiece with the obtained postage value, then the mailpiece data that is relevant for the 2D-barcode, among other things, the crypto-string, the franking date and the franking amount, are augmented by the random number, and the identification number of a customer's franking means is detected in unencrypted form, after which a hash value is generated that unambiguously identifies the content.

Since the random number is present in encrypted form within the crypto-string as well as in unencrypted form within the hash value, it is ensured that the mailing data cannot be changed or generated randomly, and information can be gleaned about the producer.

The relevant data about the mailing is then subsequently converted into a 2D-barcode and printed onto the mailpiece as the appropriate franking identification by the customer's printer. The finished mailpiece can then be introduced into the postal delivery sequence.

In an especially preferred embodiment of the payment assurance, the 2D-barcode is read in the mail center by a sender franking 2D-code reader or by a hand-held scanner and subsequently checked. The process steps associated with this are illustrated in the figure under procedure numbers 5 to 8. In order to check the correctness of the 2D-barcode, the sender franking 2D-code reader transmits all of the mailing data to the crypto-system. There, cryptographic information contained in the mailing data, especially about the crypto-string, is decrypted in order to ascertain the random number used for the creation of the hash value.

Subsequently, a hash value (also called a message digest) is ascertained for the mailing data, including the decrypted random number, and a procedure checks whether the result is 5identical to the hash value contained in the 2D-barcode.

In addition to the cryptographic validation, there are additional checking procedures for the content (procedure number 7b) that, for example, preclude that a 2D-barcode be used twice, or else that check whether the customer has become conspicuous due to attempted fraud and is consequently listed in a negative file.

The appertaining checking result is then transmitted to the PC-franking reader, which forwards the result to the optical detection system (IMM) for the encoding of the barcode. The barcode is subsequently printed onto the letter with an ink-jet printer and the mailpieces are diverted in case of a negative checking result.

Furthermore, the provided minimum payment is checked.

Moreover, the identification number (identification number of a customer's franking means) of the customer system that controls the generation of the postage indicium is checked.

This is followed by a comparison of the identification number with a negative list.

Through these checking steps, in this especially simple and advantageous manner, it is possible to discover postage indicia that have been generated without authorization.

The result of the determination is transmitted as a digital message, whereby the digital message can be transmitted, for example, to the original wireless scanner. As a result, a user of the wireless scanner can, for example, divert the mailpiece out of the mailing sequence. However, in case of an automated execution of this variant of the method, it is, of course, equally well possible to divert the mailpiece from the normal processing sequence of the mailpieces.

Preferably, the result of the checking is logged in the area of the checking unit.

The code belonging to the payment assurance incident and the appertaining text message as well as the 2D-barcode object should be returned as the return value.

Checking sequence with the sender franking 2D-code reader The input parameters of the checking routine for the sender franking 2D-code reader that are expected are likewise the session ID as well as the content of the 2D-barcode and the unambiguous identification of the sorting program that is currently active.

FIG. 4 shows an overview of the sequence of the checking procedure within the validation controller in case it was triggered by a reading system.

In order to illustrate the sequence, the figure also shows the optical detection system (IMM system) as well as the sender franking 2D-code reader so as to present the overall context of the checking procedure. However, the role of the crypto-system is limited to checking the functions between the 2D-barcode and the return as well as to logging the result.

In case of the telegram manager interface, several service tasks would be started on the validation controller that are waiting for checking request telegrams and that would call the checking routine with the telegram content. The result of the checking routine is awaited and packed into a telegram and sent back to the requesting client.

FIG. 4 shows another preferred embodiment of the control of a sequence of partial checking procedures by the checking unit (validation controller). In this additional preferred embodiment, the postage indicia are detected by an automatic optical recognition system (Prima/IMM). The data is transmitted from the optical checking unit to a reading and detection unit (sender franking 2D-code reader).

In the embodiment of the method for checking the validity of digital postage indicia shown in FIG. 4, the digital postage indicia are read in preferably in an even more automated manner, for example, by optically scanning a place on the mailpiece on which preferably a postage indicium is positioned.

The return value of the checking routine consists, on the one hand, of the payment assurance code and an appertaining message as well as of the content that has been converted and supplemented by the identification number of the customer franking means. On the basis of these return values, a telegram is generated and transmitted to the requesting reading system.

Version Number Checking

Input: current 2D-barcode object

Description:

The first three fields indicate the version of the 2D-barcode. This also shows whether the postage indicium is, in fact, a 2D-barcode of the German Postal System and not a 2D-barcode of another postal service provider. The field contents are to be compared to a list of valid values that is preconfigured in the application. If no match is found, then a payment assurance warning “PC-franking version” is returned. The checking of further content-related and cryptographic aspects is then pointless and should not be pursued.
Return value: warning code 00 if version check OK, otherwise warning code for payment assurance incident “PC-franking version”

Checking the identification number of the franking means

Input: 2D-barcode object with decrypted identification number of the franking means

Description:

The identification number of the franking means contained in the 2D-barcode is secured by a check digit method (CRC 16) that is to be checked at this juncture. Ifs this checking procedure fails, then a payment assurance warning “PC-franking suspected fraud” is to be returned as the result.

Checking Expiration of the Time Limit

Input: 2D-barcode object

Description:

This function serves for the automatic checking of the time interval between the franking of a franked mailpiece and its processing at the mail center. Only a certain number of days may lie between these two dates. The number of days depends on the product and the time needed to process it plus one extra day of leeway.

The configuration of the time period is preferably stored in a product-validity period relationship and managed centrally by means of a management mask. In the relationship, for each product key (field of the 2D-barcode) that is possible for digital franking, the applicable number of days is laid down that may lie between the franking and the processing at the mail center. In a simplified method, only one time period specification is preconfigured that relates to standard mailpieces and that is stored as a constant in the system.

For checking purposes, the number of days between the current checking date at the time of the processing and the date contained in the 2D-barcode is formed, for example, August 2 to August 1=1 day. If the number of days ascertained is larger than the value prescribed for the product, then the payment assurance code associated with the warning case “PC-franking date” is returned to the validation controller, and otherwise, a code is returned that documents the fact that the checking procedure was successful. If in a simplified method, a comparison is always made with the value for standard mailings, then after the checking result has been output, the possibility should exist to correct this checking result via a key on the scanner if the current product allows a longer processing time.

Another checking of the expiration of the time limit relates to the content of the identification number of a customer franking means. The postage value downloaded within the scope of a specification and thus also the identification number of a customer franking means have a specified period of validity during which the mailpieces have to be franked. The identification number of a customer franking means contains the point in time until which the postage value is valid. If the franking date exceeds this validity date by a certain number of days, then the payment assurance warning code belonging to the payment assurance warning “PC-franking date (postage value)” is returned.
Return value: code “00” if checking procedure OK, otherwise warning code for payment assurance incident “PC-franking date (postage value)” or “PC-franking date (franking)”

Checking the Payment

Input: 2D-barcode object; current sorting program ID

Description:

Within this function, the payment contained in the 2D-barcode is checked against a minimum payment that is defined for mailpieces of the appertaining sorting program. These amounts are in euros.

The associations between the sorting program and the minimum payment are supplied via an automatic interface.

A simplified method can be used that is similar to the checking of the expiration of the time limit. Here, a constant minimum payment is defined in the configuration file pertaining to the application, said minimum payment applying to all mailings. Therefore, the transfer of the sorting program is not necessary.

During the subsequent checking procedure, a comparison is made as to whether the minimum payment contained in the 2D-barcode lies below this value. If this is the case, then the code belonging to the payment assurance incident “PC-franking insufficient franking” is returned and otherwise the success code is returned.
Return value: code “00” if checking procedure OK, otherwise warning code for payment assurance incident “PC-franking insufficient franking”

Comparison with Negative File

Input: 2D-barcode object with decrypted identification number of a customer franking means

Description:

Within this function, it is checked whether the identification number of a customer franking means belonging to the 2D-barcode is contained in a negative file. The negative files serve to remove from the processing sequence mailpieces belonging to customers who have become conspicuous due to attempted fraud or whose PC has been stolen.

The negative files are maintained centrally within the scope of the project franking database. The method for the exchange of data with the decentralized mail center systems is to be determined within the scope of the interface for this project.

Should the management application or the data exchange not exist yet, then a transitional mechanism has to be created here. By way of a transition, this data could be managed in an Excel spreadsheet from which a csv file is generated. This file should be sent by e-mail to the checking unit and from there, it should be read into the systems via an import mechanism that would have to be provided. Later on, the transfer takes place via the path defined within the preferred payment assurance IT fine concept.

The identification number of a customer franking means identifies an individual specification that a customer calls from the system (value transfer center). These specifications are stored in a so-called safe box on the customer's system. These are hardware components in the form of a SmartCard including a reading system, or a dongle. The specification;values are securely stored in the safe box from which the customer can call individual franking amounts without being connected online to the postage value loading station (value transfer center).

Each safe box is characterized by an unambiguous ID. This safe box ID is entered into the negative file if the associated mailpieces are to be diverted due to suspicion of fraud. The safe box ID is made up of several fields. In addition to the unambiguous key, the safe box also contains additional fields such as validity date and check digit. The first three fields of the safe box ID are decisive for unambiguously identifying the safe box. These first three fields are also found in the first three fields of the PostageID, as a result of which the association between the safe box and the specification can be made. The fields are described in the table below:

| Byte | | | | |
|---|---|---|---|---|
| no. | Length | Meaning | Data content | Remark |
| b1 | 1 | Supplier | 00 | Not used |
| | | identi- | 01 | Test supplier: |
| | | fication | | postal service |
| | | | | provider |
| | | | FF | Postage point box |
| | | | | of the postal |
| | | | | service provider |
| b2 | 1 | Approved | XX | To be indicated |
| | | model | | for each |
| | | no. | | manufacturer (first |
| | | | | submitted model) |
| | | | | increasing from |
| | | | | 01 for each newly |
| | | | | approved model. |
| b3, | 3 | Serial | XX XX XX | To be indicated |
| b4, | | number of | | for each approved |
| b5 | | the model | | model of each |
| | | | | manufacturer |
| | | | | increasing from |
| | | | | 00 00 01 to FF FF |
| | | | | FF. |

If the first three fields of the identification number of a customer franking means of the franking currently being checked are identical to the first three fields of a safe box ID contained in the negative file, then the payment assurance incident associated with the customer within the negative file is returned and otherwise the success code is returned.

Return value: code “00” if checking procedure OK,

otherwise warning code associated with the customer or with the safe box in the negative file

Comparison of 2D-Barcode Content to the Mailpiece Plain Text

Input: 2D-barcode object

Description:

In order to prevent that copies of 2D-barcodes can be created, a comparison is carried out between the mailing data encoded in the 2D-barcode and the data shown in plain text on the letter. With the wireless scanners, this comparison can be made directly since they have sufficient display and input capabilities. With the hand-held scanners with a wire connection, the checking procedure is to be carried out on the PC (payment assurance system).

The sequence is such that the validation controller, after the conclusion of the automated checking procedures, initiates the output of the data of the 2D-barcode on the wireless scanner, or on the payment assurance PC. For this purpose, a callback method is available that is associated at the beginning of a session.

The PC calls this callback method with the current 2D-barcode object. Then the scanner controller or the payment assurance PC becomes responsible for the depiction of the 2D-barcode content and they return a “00” or an appertaining error code to the callback method as the return value (after being processed by the examiner).

If the evaluation has succeeded, the success code or otherwise the code of the payment assurance warning “PC-franking plain text” is returned.

This checking procedure is not necessary in the case of automated checking. Here, the checking can preferably be carried out within the scope of the central evaluations offline either by means of throughput comparisons or by means of a comparison of the destination postal code with the postal code contained in the 2D-barcode.
Return value: code “00” if checking procedure OK, otherwise warning code for payment assurance incident “PC-franking plain text”

Cryptographic Checking Procedures

The cryptographic checking procedure consists of two parts:

a) the decryption of the crypto-string and

b) the hash value comparison.

Both methods are to be carried out in the secure area of the crypto-card since otherwise, a customer could generate valid franking hash values by spying on the information used for the processing.

Decrypting the Crypto-String

Input: 2D-barcode object

Description:

As the input parameter, this function receives the split 2D-barcode object of the scanner result. On the basis of the franking date and the key number, the symmetrical key that is valid for this point in time is looked up and the crypto-string of the transferred object is decrypted using this key according to the Triple DES CBC method. Within the framework of the interface to the payment assurance system, a decision is made about the value that is to be ascribed to the initialization vector, and whether the process is to be carried out with inner-bound or outer-bound CBC and with which block length this is being done.

If the key contained in the 2D-barcode is not present in the crypto-system, then the payment assurance warning “suspicion of fraud (key)” is returned with the error message that the key with the key number was not found.

The result of the operation consists of the decrypted identification number of a customer franking means as well as the decrypted random number. The decrypted PostageID is entered in an appropriate field of the 2D-barcode object. For security reasons, the random number should not be made known since, if the customer had access to this information, he/she could generate valid hash values and could thus forge 2D-barcodes.

After the decryption, the hash value calculation is called from the method and its return value is returned.

Hash Value Calculation

Input: 2D-barcode object

Decrypted random number from the crypto-string (the decrypted random number must not be known outside of the card)

Description:

The function of the hash value calculation determines the first 60 bytes from the original scanner result contained in the 2D-barcode object. The decrypted identification number of a customer franking means as well as the transferred decrypted random number are added to this. Then, by means of the method SHA 1, a hash value is calculated on the basis of and compared to the hash value of the 2D-barcode contained in the 2D-barcode object. If all 20 bytes match, then the cryptographic checking procedure has been successful and an appertaining return value is returned.

If there is no match, then a payment assurance warning “PC-franking suspicion of fraud (hash value)” is returned to the validation controller.

The calculated hash value is also transmitted as the return value, so that it can be output along with the checking result.
Return value: calculated hash value code “00” if checking procedure OK, otherwise warning code for payment assurance incident “PC-franking suspicion of fraud (hash value)” or “PC-franking suspicion of fraud (key)”

Result Output

Depiction of the Checking and Reading Result

Description:

Via a callback method, the validation controller has the possibility to actuate a result output on the output device involved in the current checking procedure. For this purpose, it returns the 2D-barcode object and the determined payment assurance warning code to this callback method. The code of the reprocessing method selected by the checking unit can be supplied as the return value.

Likewise at the beginning of the session, the callback method for the output is assigned at the time of the log-on to the validation controller.

Result Logging

Input: 2D-barcode object, code of the checking result

Description:

The logging of the result is carried out with a simplified process in a file on the system on which the validation controller is running. As a rule, the results or the correction records are transmitted directly to the BDE and written into the database of the preferred local payment assurance system via the preferred payment assurance BDE interface.

Preferably, the identification number of a customer franking means, the consecutive number, the franking date, the payment, the product key, the postal code, the payment assurance result code, the message text, the duration of the checking procedure, the point in time of the checking procedure, the ID of the scanner, the mode of operation of the scanner, the detection modality, as well as the type of further processing are all stored. All of these values—separated from each other by a semicolon—are output in a batch per mailing and can thus be further evaluated, for example, in Excel.

If the system is in the mode of operation “first detection”, then an “f” should be entered into the column for the detection mode and otherwise an “s” for subsequent detection.

Master Data Provision

Description:

Numerous items of master data are advantageous for checking the content. These are the following:

PC-franking negative file

sorting programs and minimum payments

general minimum payment

product key PC-franking

maximum delivery time per PC-franking product key

general maximum delivery time

payment assurance incidents, priorities and association with further processing instructions

further processing instructions

Master data can have a fixed preconfiguration during a transition time except for the PC-franking negative file as well as the cryptographic key of the postage value loading station (value transfer center).

If necessary, simple processing and distribution applications can be implemented for some of the data. This data can be managed, for example, in an Excel spreadsheet from which a csv file is generated. This file should be sent by e-mail to the checking unit and from there, it should be read into the systems via an import mechanism that would have to be provided.

The embodiments shown are to be understood only by way of example. While the use of individual measures already increases the accuracy and completeness of the payment invoicing and contributes to simplifying process sequences, the entire cooperation of the components brings about a synergistic utilization of the detected information and combinations thereof.

Thus, in especially advantageous embodiments, it is possible not only to improve the benefit for the postal service provider by increasing the payment security but also to transmit additional information to the mailers of mailpieces, for example, about the processing of mailpieces and/or about the presence of a delivery structure.

1-24. (canceled)

25. A method for processing mailpieces having graphic information located on a surface of a mailpiece comprising:
ascertaining the graphic information;
associating the mailpiece with a mailing type on the basis of the ascertained graphic information;
identifying at least one of the mailpiece, a mailer, and a recipient's address on the basis of the mailing type;
determining a number of mailpieces processed for the mailer from the identified mailpiece, the mailer or the recipient's address;
combining the ascertained graphic information from a plurality of mailpieces;
determining a delivery structure from the combination of graphic information;
comparing the number of mailpices processed for the mailer and the delivery structure to a delivery job batch; and
comparing the delivery job batch to a customer data record that contains one of a prepaid postage value and a limit postage value;
wherein the delivery job batch is transmitted by a customer or created if a customer does not transmit the delivery job batch.

26. The method of claim 25 wherein the step of ascertaining includes ascertaining at least one additional piece of payment-relevant information about the mailpiece.

27. The method of claim 25 wherein the step of ascertaining the delivery structure includes checking whether the mailpiece was pre-sorted by the mailer.

28. The method of claim 27 wherein the step of determining the delivery structure further includes checking whether the pre-sorting was carried out on the basis of addresses of the recipient.

29. The method of claim 27 wherein the step of determining the delivery structure further includes checking whether the pre-sorting was carried out on the basis of postal codes of the recipient.

30. The method of claim 27 wherein the step of determining the delivery structure further includes checking whether the mailpieces were pre-sorted according to mailing properties.

31. The method of claim 27 wherein the step of determining the delivery structure further includes checking whether the pre-sorting was carried out according to one or more size specifications.

32. The method of claim 27 wherein the step of determining the delivery structure further includes checking whether the pre-sorting was carried out according to the weight of the mailpieces.

33. The method of claim 25 wherein the step of ascertaining the graphic information includes ascertaining an identification number for the mailpiece and invoicing the mailpiece according to the identification number.

34. The method of claim 25 wherein the step of ascertaining the graphic information includes ascertaining a customer number for the mailpiece and invoicing the mailpiece according to the customer number.

35. The method of claim 25 further including one of the step of ascertaining an invoicing database on the basis of the number of mailpieces processed for the mailer and the step of ascertaining the invoicing database on the basis of the delivery structure.

36. The method of claim 25 further including the step of transmitting the delivery job batch to a customer data management system, the customer data management system determining whether there are discrepancies between an invoicing data record and the delivery job batch, and if there are discrepancies, the customer data management system recording the discrepancies in a differential protocol.

37. The method of claim 25 further including the step of checking whether the customer has transmitted the delivery job batch, and if the customer has not transmitted the delivery job batch, generating a delivery job batch automatically.

38. The method of claim 25 further including the step of issuing a delivery confirmation to the mailer on the basis of the graphic information.

39. The method of claim 38 wherein the delivery confirmation contains one or more components of the delivery structure.

40. The method of claim 25 further including checking the authenticity of franking information by using the mailing type, transmitting the mailpieces to a reading device and transmitting the graphic information of each mailpiece, according to the mailing type, to a specialized reading device that checks the authenticity of each particular type of franking.

41. The method of claim 40 comprising ascertaining the graphic information is associated with a type of franking by means of an image processing unit.

42. The method of claim 40 comprising selecting the specialized reading device as a function of the current capacities of available reading devices.

43. The method of claim 25 further including the step of comparing the ascertained graphic information to an expected graphic information and transmitting any differences to a central image processing unit for another comparison.

44. The method of claim 25 further including the step of comparing the ascertained graphic information to an expected graphic information and determining an expected payment for the mailpiece from the comparison.

45. The method of claim 44 wherein the comparison of the ascertained graphic information to the expected graphic information includes the steps of comparing the detected graphic information to the expected graphic information via a means in the area of the mail processing station and comparing any discrepancies between the ascertained graphic information and the expected graphic information via a specialized reading device.

46. The method of claim 25 further including the step of transmitting the detected graphic information and any accompanying information to an image processing machine.

47. The method of claim 46 wherein the accompanying information includes results from comparing the detected graphic information and the expected graphic information.

48. The method of claim 25 further including the step of sorting the mailpieces as a function of the detected graphic information.
